(19) United States
(12) Patent Application Publication
(10) Pub. No.: US 2026/0208217 A1
(43) Pub. Date: Jul. 23, 2026

(54) LIQUID PRESSING CONTAINER WITH CLEARANCE FEATURE

(71) Applicant: Zhongshan Weiyuan Packaging LTD., Zhongshan (CN)

(72) Inventor: Guangwei ZHU, Zhongshan (CN)

(73) Assignee: Zhongshan Weiyuan Packaging LTD., Zhongshan (CN)

(21) Appl. No.: 19/216,164

(22) Filed: May 22, 2025

(30) Foreign Application Priority Data
Jan. 23, 2025 (CN) 202520162986.6

(51) Int. Cl. B05B 11/00

(52) U.S. Cl. CPC B05B 11/0044

(57) ABSTRACT

A liquid pressing container with a clearance feature is disclosed. The container includes a bottle body, a pump head, and a locking member, where at least one clearance feature is arranged between a main column of the pump head extending into an interior of the bottle body and the locking member, and the at least one clearance feature is configured to form a first gap between an outer side surface of the main column and an inner side surface of the locking member.

### CROSS-REFERENCE TO RELATED APPLICATION

This application is based on and claims the benefit of priority from Chinese Patent Application No. 202520162986.6, filed on Jan. 23, 2025, the entirety of which is incorporated by reference herein.

### TECHNICAL FIELD

The present disclosure relates to, but is not limited to, the technical field of container packaging, and in particular, to a liquid pressing container with a clearance feature.

### BACKGROUND

Liquid pressing bottles are one of the necessities in life and are widely used in containers for liquids, such as a shower gel, a body lotion, and a detergent, to discharge a liquid from the container by utilizing the principle of press-type liquid suction. However, when a user takes the liquid pressing bottle out and the liquid pressing bottle needs to be air-transported, the product is exposed to an extreme air pressure change environment, and the thick liquid stored in the liquid pressing bottle may accidentally seep into a pump body through an exhaust hole. After entering the pump body, this thick liquid will accumulate in the original exhaust channel, thereby blocking the channel or significantly reducing its exhaust efficiency. This not only affects the normal use of the product, causing a decrease in smoothness when the liquid pressing bottle is pressed, but may also cause the container to deform due to the unbalanced internal pressure, resulting in a flat bottle, or even cause the pump head to fail and the liquid to be unable to be discharged normally.

### SUMMARY

The following is a summary of the subject matter described in detail herein. This summary is not intended to limit the scope of the claims. Embodiments of the present disclosure aim to solve at least one of the technical problems existing in the existing technologies. A main objective of the embodiments of the present disclosure is to provide a liquid pressing container with a clearance feature, which aims to effectively balance the air pressure inside and outside the bottle body and prevent the container from being deformed due to internal pressure imbalance, thereby improving the liquid discharge efficiency and stability.

To achieve the above objective, an embodiment of the present disclosure provides a liquid pressing container with a clearance feature, which includes a bottle body, a pump head, and a locking member, where at least one clearance feature is arranged between a main column of the pump head extending into an interior of the bottle body and the locking member, and the at least one clearance feature is configured to form a first gap between the outer side surface of the main column and the inner side surface of the locking member.

The beneficial effects of the embodiments of the present disclosure are as follows. By arranging at least one clearance feature between the main column and the locking member, where the at least one clearance feature is configured to form the first gap between the outer side surface of the main column and the inner side surface of the locking member, the problem that the liquid is accumulated in the exhaust channel to block the channel or significantly reduce its exhaust efficiency can be effectively avoided, thereby ensuring that the exhaust channel can continuously and effectively balance the air pressures inside and outside the bottle body, preventing the container from being deformed due to internal pressure imbalance, improving the liquid discharge efficiency and stability, and thereby enhancing the user experience.

In a possible implementation, the at least one clearance feature is arranged on an outer side surface of the main column.

In a possible implementation, the outer side surface of the main column includes a first main column side surface, an angled main column surface, and a second main column side surface, the first main column side surface is connected to the second main column side surface through the angled main column surface, a diameter of the first main column side surface is greater than a diameter of the second main column side surface, and the at least one clearance feature is arranged on the second main column side surface.

In a possible implementation, the second main column side surface includes a first arc surface and at least one first flat surface, the first arc surface is connected to the at least one first flat surface, and the at least one first flat surface forms the at least one clearance feature respectively.

Alternatively, the second main column side surface includes a first arc surface and at least one first cambered surface recessed towards a center axis of the main column, the first arc surface is connected to the at least one first cambered surface, and the at least one first cambered surface forms the at least one clearance feature respectively.

In a possible implementation, the at least one clearance feature is arranged on an inner side surface of the locking member.

In a possible implementation, the inner side surface of the locking member includes a first inner side surface and a second inner side surface, the first inner side surface is connected to the second inner side surface, and the at least one clearance feature is arranged on the first inner side surface.

In a possible implementation, the first inner side surface includes at least one second cambered surface that is recessed inwardly, and the at least one second cambered surface forms the at least one clearance feature respectively.

In a possible implementation, an outer wall portion of the pump head extending into the interior of the bottle body is provided with an exhaust hole, and the exhaust hole faces the inner side surface of the bottle body.

In a possible implementation, the outer wall portion includes a first outer wall surface, an angled outer wall surface, and a second outer wall surface, the first outer wall surface is connected to the second outer wall surface through the angled outer wall surface, and the exhaust hole is formed in the second outer wall surface or the angled outer wall surface.

In a possible implementation, an outer side surface of the locking member includes a first outer side surface, a horizontal outer side surface, and a second outer side surface, the first outer side surface is connected to the second outer side surface through the horizontal outer side surface, the second outer side surface is positioned corresponding to the position of the exhaust hole, and a second gap is formed between the second outer side surface and the outer wall portion.

In order to make the above-mentioned objectives, features, and advantages of the present disclosure apparent and easy to understand, some embodiments are specifically cited below and described in detail with reference to the accompanying drawings.

### BRIEF DESCRIPTION OF DRAWINGS

In order to clearly illustrate one or more embodiments of this specification or the technical schemes in the existing technologies, the accompanying drawings required for use in the description of one or more embodiments or the existing technologies will be briefly introduced below. Apparently, the accompanying drawings described below are only some embodiments recorded in this Specification. Those of ordinary skill in the art can obtain other drawings based on these accompanying drawings without creative efforts.

FIG. 1 is a front cross-sectional view of a liquid pressing container with a clearance feature provided in an embodiment of the present disclosure;

FIG. 2 is a structural diagram of a main column provided in an embodiment of the present disclosure;

FIG. 3 is a front cross-sectional view of a liquid pressing container with a clearance feature provided in another embodiment of the present disclosure;

FIG. 4 is a structural diagram of a pump head provided in an embodiment of the present disclosure; and

FIG. 5 is a front cross-sectional view of a liquid pressing container with a clearance feature provided in yet another embodiment of the present disclosure.

Reference numerals: bottle body 100, pump head 200, locking member 300, main column 210, clearance feature 211, first main column side surface 212, angled main column surface 213, second main column side surface 214, first inner side surface 310, second inner side surface 320, exhaust hole 220, first outer wall surface 221, angled outer wall surface 222, second outer wall surface 223, first outer side surface 330, horizontal outer side surface 340, second outer side surface 350.

### DETAILED DESCRIPTION

In order to enable those skilled in the art to understand the technical schemes in this Specification, the technical schemes in one or more embodiments of this Specification will be clearly and completely described below in conjunction with the accompanying drawings in one or more embodiments of this Specification. Apparently, the one or more embodiments described are only part of the embodiments of this Specification, not all of the embodiments. All other embodiments obtained by those of ordinary skill in the art without creative efforts based on one or more embodiments in this Specification should fall within the scope of protection of the present disclosure.

It should be noted that although the functional modules are divided in the device schematic diagram and the logical order is shown in the flowchart, in some cases, the device can have different module divisions, and the steps shown or described may be performed in a different order than the order in the flowchart. The terms such as “first”, “second”, etc. in this Specification, Claims and the above accompanying drawings are used to distinguish similar objects and are not necessarily used to describe a specific sequence or order.

Unless defined otherwise, all technical and scientific terms used herein have the same meaning as commonly understood by those skilled in the art to which the present disclosure belongs. The terms used herein are only for the purpose of describing the embodiments of the present disclosure and are not intended to limit the present disclosure.

It should be noted that similar reference numerals and letters denote similar items in the following accompanying drawings, and thus, once an item is defined in a drawing, further definition and explanation thereof is not required in subsequent drawings.

In addition, the technical features involved in each embodiment of the present disclosure described below can be combined with each other as long as they do not conflict with each other. The embodiments of the present disclosure will be further described in conjunction with the accompanying drawings.

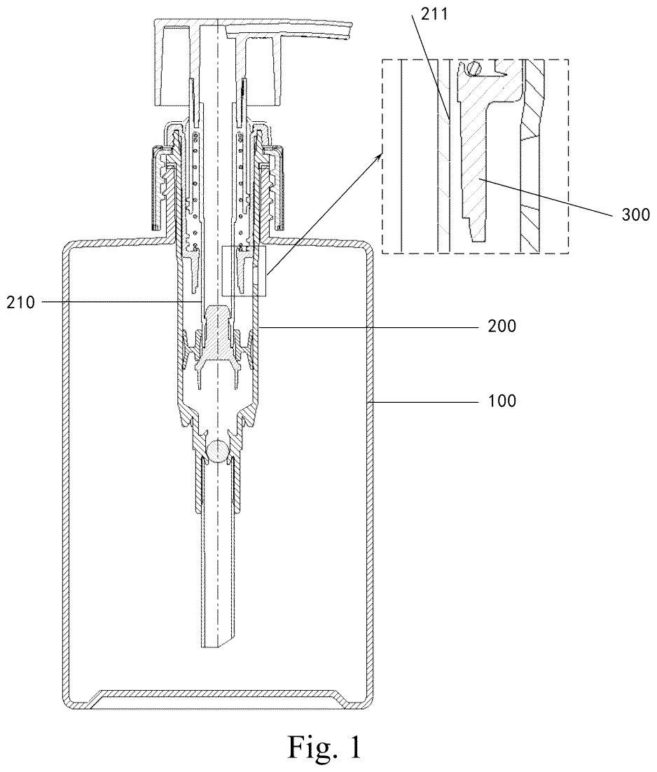

As shown in FIG. 1, FIG. 1 is a front cross-sectional view of a liquid pressing container with a clearance feature 211 provided in an embodiment of the present disclosure. The liquid pressing container includes a bottle body 100, a pump head 200, and a locking member 300. At least one clearance feature 211 is arranged between a main column 210 extending into the interior of the bottle body 100 and the locking member 300. The clearance feature 211 is configured to form a first gap between the outer side surface of the main column 210 and the inner side surface of the locking member 300 (FIG. 1 shows that the clearance feature 211 is arranged on the main column 210).

It should be noted that the at least one clearance feature 211 is arranged between the main column 210 and the locking member 300 of the liquid pressing container provided in the embodiment of the present disclosure, such that the first gap is formed between the outer side surface of the main column 210 and the inner side surface of the locking member 300, which effectively increases the exhaust channel in the liquid pressing container, and can effectively avoid the problem that the liquid is accumulated in the exhaust channel to block the channel or significantly reduce its exhaust efficiency, thereby ensuring that the exhaust channel can continuously and effectively balance the air pressures inside and outside the bottle body, preventing the container from being deformed due to internal pressure imbalance, improving the liquid discharge efficiency and stability, and thereby enhancing the user experience. In addition, the first gap can also reduce the friction between the pump head 200 and the bottle body 100, making the operation easier. In addition, the bottle body 100 and the pump head 200 can be made of a high-quality plastic, which not only ensures the durability of the container but also reduces the production cost.

It should also be noted that the locking member 300 is configured to lock the pump head 200 and the bottle body 100 to prevent the pump head 200 from popping out due to looseness, or to prevent a condition that the liquid is wasted as the liquid in the container flows out due to accidental touch.

The embodiment of the present disclosure does not limit the specific shape, width, and depth of the first gap, ensuring that the outer side surface of the main column 210 and the inner side surface of the locking member 300 can be effectively avoided from abutting against each other without causing excessive impact on the overall structure of the container.

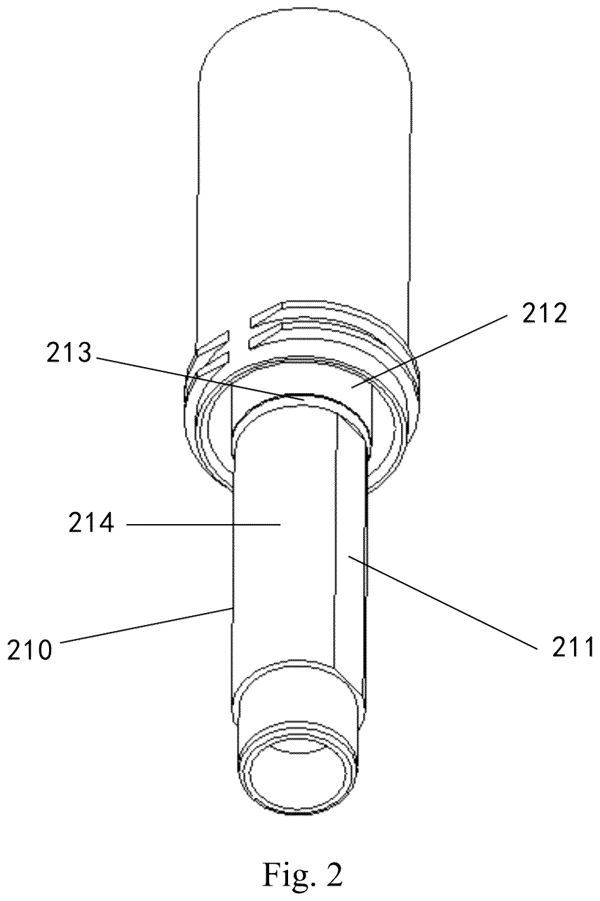

In a possible implementation, as shown in FIG. 2, the clearance feature 211 is arranged on the outer side surface of the main column 210.

It should be noted that the clearance feature 211 is arranged on the outer side surface of the main column 210, which is equivalent to reducing part of the volume of the main column 210, such that the first gap is formed between the outer side surface of the main column 210 and the inner side surface of the locking member 300. The gap can effectively balance the air pressures inside and outside the bottle body to prevent the container from being deformed due to internal pressure imbalance. The clearance feature 211 is formed in the embodiment of the present disclosure by reducing part of the volume of the main column 210, which effectively increases the exhaust channel in the liquid pressing container, and can effectively avoid the problem that the liquid is accumulated in the exhaust channel to block the channel or significantly reduce its exhaust efficiency, thereby ensuring that the exhaust channel can continuously and effectively balance the air pressure inside and outside the bottle body, preventing the container from being deformed due to internal pressure imbalance, improving the liquid discharge efficiency and stability, and thereby improving the user experience.

In a possible implementation, as shown in FIG. 2, the outer side surface of the main column 210 includes a first main column side surface 212, an angled main column surface 213, and a second main column side surface 214. The first main column side surface 212 is connected to the second main column side surface 214 through the angled main column surface 213, a diameter of the first main column side surface 212 is greater than a diameter of the second main column side surface 214, and the clearance feature 211 is arranged on the second main column side surface 214.

It should be noted that the outer side surface of the main column 210 includes a first main column side surface 212, an angled main column surface 213, and a second main column side surface 214. The first main column side surface 212 is connected to the second main column side surface 214 through the angled main column surface 213. The diameter of the first main column side surface 212 is greater than the diameter of the second main column side surface 214 to form the first gap between the second main column side surface 214 and the inner side surface of the locking member 300. Furthermore, by forming the first gap between the second main column side surface 214 and the inner side surface of the locking member 300, and arranging the clearance feature 211 on the second main column side surface 214, a distance between the second main column side surface 214 and the inner side surface of the locking member 300 can be effectively increased without causing excessive impact on the overall structure of the container, that is, the exhaust channel in the liquid pressing container is increased, which can effectively avoid the problem that the liquid is accumulated in the exhaust channel to block the channel or significantly reduce its exhaust efficiency, thereby ensuring that the exhaust channel can continuously and effectively balance the air pressure inside and outside the bottle body, preventing the container from being deformed due to internal pressure imbalance, improving the liquid discharge efficiency and stability, and thereby improving the user experience.

It should also be noted that the embodiment of the present disclosure does not limit the number of the clearance features 211, which can be one or more. When there are a plurality of clearance features 211, these clearance features 211 can be evenly distributed on the second main column side surface 214. This can further improve the gas discharge efficiency and ensure that the container always maintains a stable pressure during use.

In a possible implementation, the second main column side surface 214 includes a first arc surface and a first flat surface. The first arc surface is connected to the first flat surface, and the first flat surface forms the clearance feature 211. Alternatively, the second main column side surface 214 includes a first arc surface and a first cambered surface recessed towards a central axis of the main column 210, the first arc surface is connected to the first cambered surface, and the first cambered surface forms the clearance feature 211.

It should be noted that the clearance feature(s) 211 provided in the embodiment of the present disclosure can be arranged as a first flat surface(s) or as a first cambered surface(s) recessed towards the central axis of the main column 210, both of which can effectively increase the distance between the second main column side surface 214 and the inner side surface of the locking member 300, that is, increase the exhaust channel in the liquid pressure container. In addition, it should be appreciated that the embodiment of the present disclosure does not limit the shape of the clearance feature(s) 211. In a case where a plurality of clearance features 211 are provided, the shape of the clearance feature(s) 211 can be adjusted accordingly to accommodate the layout of the plurality of clearance features 211.

In a possible implementation, the clearance feature(s) 211 is/are arranged on an inner side surface of the locking member 300.

It should be noted that, in the present disclosure, in addition to making such designs on the second main column side surface 214 to form the first gap between the second main column side surface 214 and the inner side surface of the locking member 300, designs can also be made on the inner side surface of the locking member 300 to achieve the same first gap structure. In this case, the inner side surface of the locking member 300 can be molded to have a specific contour or shape so as to create an unobstructed passage between the second main column side surface 214 and the inner side surface of the locking member 300.

In a possible implementation, the inner side surface of the locking member 300 includes a first inner side surface 310 and a second inner side surface 320, the first inner side surface 310 is connected to the second inner side surface 320, and the clearance feature 211 is arranged on the first inner side surface 310.

In some embodiments of the present disclosure, the inner side surface of the locking member 300 includes a first inner side surface 310 and a second inner side surface 320. The clearance feature 211 is arranged on the first inner side surface 310, such that the first gap is formed between the first inner side surface 310 and the side surface of the main column, which can effectively increase the distance between the first inner side surface 310 and the side surface of the main column, that is, increase the exhaust channel in the liquid pressing container, ensuring that the exhaust channel can continuously and effectively balance the air pressures inside and outside the bottle.

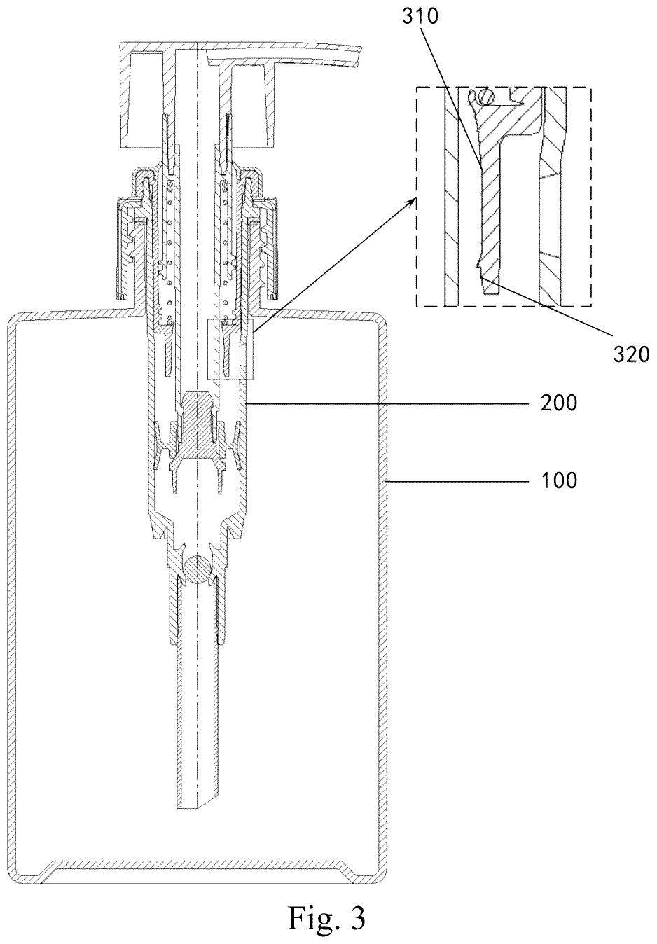

In a possible implementation, as shown in FIG. 3, the first inner side surface 310 includes a second cambered surface that is recessed inwardly, and the second cambered surface forms the clearance feature 211.

It should be noted that by arranging the second cambered surface that is recessed inwardly in the first inner side surface 310 of the locking member 300, the second arc surface forming the clearance feature 211, the first gap is formed between the first inner side surface 310 and the side surface of the main column, which can effectively increase the distance between the first inner side surface 310 and the side surface of the main column, that is, increase the exhaust channel in the liquid pressing container. In addition, it should be appreciated that the embodiments of the present disclosure does not limit the shape of the clearance feature 211, and the shape of the clearance feature 211 can be adjusted accordingly to accommodate the layout of the plurality of clearance features 211.

It should also be noted that the embodiment of the present disclosure does not limit the number of the clearance features 211, which can be one or more. When there are a plurality of clearance features 211, the clearance features 211 can be evenly distributed on the inner side surface of the locking member 300. This can further improve the gas discharge efficiency and ensure that the container always maintains a stable pressure during use.

In a possible implementation, an outer wall portion of the pump head 200 extending into the interior of the bottle body 100 is provided with an exhaust hole 220, and the exhaust hole 220 faces the inner side surface of the bottle body 100.

In some embodiments of the present disclosure, the exhaust hole 220 faces the inner side surface of the bottle body 100, such that when the pump head 200 is used, it can ensure that the gas inside the bottle body 100 can be discharged smoothly. Furthermore, the exhaust hole 220 faces the inner side surface of the bottle body 100, that is, there is a large space between the exhaust hole 220 and the inner side surface of the bottle body 100, which can effectively prevent the exhaust hole 220 from being accidentally blocked, thereby ensuring smooth flow of gases inside and outside the container, thereby improving the use efficiency of the container and user experience. In addition, the embodiment of the present disclosure does not limit the size and shape of the exhaust hole 220, and only needs to ensure that the gas can flow smoothly without being blocked due to inappropriate size or shape.

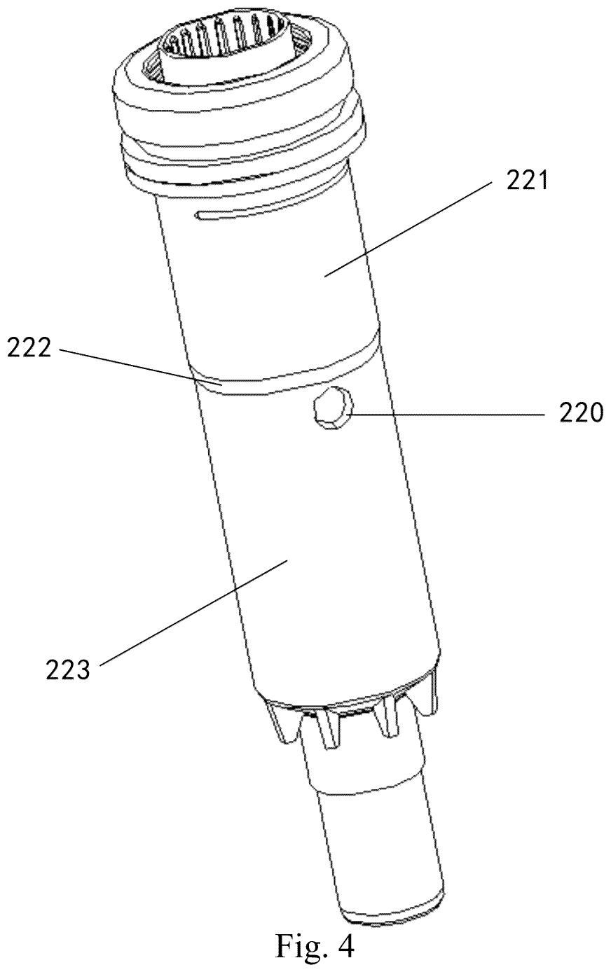

In a possible implementation, as shown in FIG. 4, the outer wall portion includes a first outer wall surface 221, an angled outer wall surface 222, and a second outer wall surface 223, the first outer wall surface 221 is connected to the second outer wall surface 223 through the angled outer wall surface 222, and the exhaust hole 220 is formed in the second outer wall surface 223 or the angled outer wall surface 222 (FIG. 4 shows that the exhaust hole 220 is formed in the second outer wall surface 223).

In some embodiments of the present disclosure, the outer wall portion of the pump head 200 extending into the interior of the bottle body 100 includes a first outer wall surface 221, an angled outer wall surface 222, and a second outer wall surface 223. The first outer wall surface 221 is connected to the second outer wall surface 223 through the angled outer wall surface 222. The exhaust hole 220 is formed in the second outer wall surface 223 or the angled outer wall surface 222, which can effectively avoid a risk that the air pressures inside and outside the bottle body cannot be balanced because the first outer wall surface 221 abuts against a casing wall of a bottleneck of the bottle body 100 to lead to blockage of the exhaust hole 220 by the liquid as the exhaust hole 220 is formed in the first outer wall surface 221 to further affect flow of the gas. By forming the exhaust hole 220 in the second outer wall surface 223 or the angled outer wall surface 222, the distance between the exhaust hole 220 and the bottle body 100 can be increased, thereby preventing the exhaust hole 220 from being accidentally blocked, ensuring smooth flow of gas inside and outside the container, and thereby improving the use efficiency and user experience of the container.

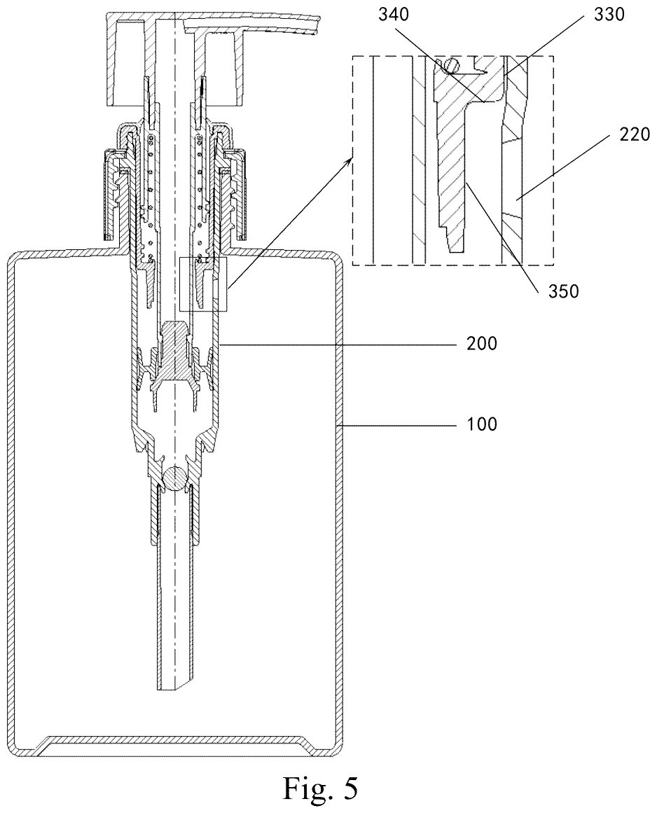

In a possible implementation, as shown in FIG. 5, an outer side surface of the locking member 300 includes a first outer side surface 330, a horizontal outer side surface 340, and a second outer side surface 350, the first outer side surface 330 is connected to the second outer side surface 350 through the horizontal outer side surface 340, the position of the second outer side surface 350 corresponds to the position of the exhaust hole 220, and a second gap is formed between the second outer side surface 350 and the outer wall portion.

It should be noted that, as shown in the figure, by forming the exhaust hole 220 in the second outer wall surface 223 or the angled outer wall surface 222, the position of the exhaust hole 220 corresponds to the position of the second outer side surface 350 of the locking member 300, and the second gap is formed between the second outer side surface 350 and the outer wall portion, thereby preventing the exhaust hole 220 from being blocked by the liquid due to the first outer wall surface 221 abutting directly against the first outer side surface 330 of the locking member 300 that would occur if the exhaust hole 220 locates on the first outer wall surface 221, which would impede the gas flow and further compromise air pressure unbalance inside and outside the bottle body. The position of the second outer side surface 350 corresponds to the position of the exhaust hole 220, which can increase the distance between the exhaust hole 220 and the second outer side surface 350, thereby preventing the exhaust hole 220 from being accidentally blocked, ensuring smooth flow of gas inside and outside the container, and thereby improving the usage efficiency and user experience of the container.

It should be appreciated that the liquid in the liquid pressing container can be a shampoo, a conditioner, a shower gel, hand soap, various cosmetic lotions, a liquid medicine, a seasoning and liquid food, and the like, which is not limited herein.

The embodiments described in the embodiments of the present disclosure are intended to clearly illustrate the technical schemes of the embodiments of the present disclosure and do not constitute a limitation on the technical solutions schemes in the embodiments of the present disclosure. Those skilled in the art will appreciate that with the evolution of technology and the emergence of new application scenarios, the technical schemes provided in the embodiments of the present disclosure are also applicable to similar technical problems.

Those skilled in the art can understand that the technical schemes shown in the figures do not constitute a limitation on the embodiments of the present disclosure, and can include more or fewer steps than those shown in the figures, or a combination of certain steps, or different steps.

The device embodiments described above are merely schematic, where the units described as separate components can or cannot be physically separated, that is, can be located in one place, or can be distributed over a plurality of network units. Some or all of the modules can be selected according to actual needs to achieve the purpose of the schemes in the embodiments.

In the present disclosure, unless otherwise expressly specified or limited, the terms such as “mounted”, “in connection with”, “connected”, “fixed”, and the like should be understood in a broad sense, for example, it can be a fixed connection, a detachable connection, or an integral connection; it can be a mechanical connection or an electrical connection; it can be a direct connection or an indirect connection through an intermediate medium. It can be the internal connectivity between two elements or the interaction between two elements. A person having ordinary skills in the art can understand the specific meanings of the above terms in the present disclosure according to specific circumstances.

In the present disclosure, unless otherwise clearly specified and limited, a first feature is “on” or “under” a second feature, which can include direct contact between the first and second features, or include contact between the first and second features through additional features therebetween rather than the direct contact therebetween. Moreover, the first feature is “over”, “above”, and “on” the second feature, which includes that the first feature is directly above and obliquely above the second feature, or simply means that the first feature is at a higher level than the second feature. The first feature is “under,” “beneath,” and “below” the second feature, which includes that the first feature is directly below and diagonally below the second feature, or simply means that the first feature is at a lower level than the second feature.

The above descriptions are merely some implementations of the present disclosure and are not intended to limit the present disclosure. For those skilled in the art, the present disclosure may have various modifications and changes. Any modifications, equivalent substitutions, improvements, and the like made within the gist and principles of the present disclosure should be included in the protection scope of the present disclosure.

What is claimed is:

1. A liquid pressing container with a clearance feature, comprising a bottle body, a pump head, and a locking member, wherein at least one clearance feature is arranged between a main column of the pump head extending into an interior of the bottle body and the locking member, and the at least one clearance feature is configured to form a first gap between an outer side surface of the main column and an inner side surface of the locking member.

2. The liquid pressing container according to claim 1, wherein the at least one clearance feature is arranged on the outer side surface of the main column.

3. The liquid pressing container according to claim 2, wherein the outer side surface of the main column comprises a first main column side surface, an angled main column surface, and a second main column side surface, the first main column side surface is connected to the second main column side surface through the angled main column surface, a diameter of the first main column side surface is greater than a diameter of the second main column side surface, and the at least one clearance feature is arranged on the second main column side surface.

4. The liquid pressing container according to claim 3, wherein:
the second main column side surface comprises a first arc surface and at least one first flat surface, the first arc surface is connected to the at least one first flat surface, and the at least one first flat surface forms the at least one clearance feature respectively; or
the second main column side surface comprises a first arc surface and at least one first cambered surface recessed towards a center axis of the main column, the first arc surface is connected to the at least one first cambered surface, and the at least one first cambered surface forms the at least one clearance feature respectively.

5. The liquid pressing container according to claim 1, wherein the at least one clearance feature is arranged on an inner side surface of the locking member.

6. The liquid pressing container according to claim 5, wherein the inner side surface of the locking member comprises a first inner side surface and a second inner side surface, the first inner side surface is connected to the second inner side surface, and the at least one clearance feature is arranged on the first inner side surface.

7. The liquid pressing container according to claim 6, wherein the first inner side surface comprises at least one second cambered surface that is recessed inwardly, and the at least one second cambered surface forms the at least one clearance feature respectively.

8. The liquid pressing container according to claim 1, wherein an exhaust hole is formed in an outer wall portion of the pump head extending into the interior of the bottle body, and the exhaust hole faces the inner side surface of the bottle body.

9. The liquid pressing container according to claim 8, wherein the outer wall portion comprises a first outer wall surface, an angled outer wall surface, and a second outer wall surface, the first outer wall surface is connected to the second outer wall surface through the angled outer wall surface, and the exhaust hole is formed in the second outer wall surface or the angled outer wall surface.

10. The liquid pressing container according to claim 9, wherein an outer side surface of the locking member comprises a first outer side surface, a horizontal outer side surface, and a second outer side surface, the first outer side surface is connected to the second outer side surface through the horizontal outer side surface, the second outer side surface is positioned corresponding to a position of the exhaust hole, and a second gap is formed between the second outer side surface and the outer wall portion.
